(19) United States
(12) Patent Application Publication
(10) Pub. No.: US 2026/0286862 A1
(43) Pub. Date: Sep. 24, 2026

(54) TURBINE RING ASSEMBLY WITH A SEALING PLATE

(71) Applicant: SAFRAN AIRCRAFT ENGINES, Paris (FR)

(72) Inventors: Clément JARROSSAY, Moissy-Cramayel (FR); Sébastien Serge Francis CONGRATEL, Moissy-Cramaye (FR); Clément Emile André CAZIN, Moissy-Cramayel (FR); Arthur NIMHAUSER, Moissy-Cramayel (FR); Moncef M'HASNI, Moissy-Cramayel (FR)

(73) Assignee: SAFRAN AIRCRAFT ENGINES, Paris (FR)

(21) Appl. No.: 19/469,992

(22) PCT Filed: Mar. 28, 2024
(86) PCT No.: PCT/FR2024/050400

§ 371 Date: Sep. 26, 2025

(30) Foreign Application Priority Data
Mar. 29, 2023 (FR) FR2303041

(51) Int. Cl. F01D 25/24; F01D 11/08

(52) U.S. Cl. CPC F01D 25/24; F01D 11/08; F05D 2240/55; F05D 2300/6033

(57) ABSTRACT

A turbine ring assembly provided with a segmented turbine ring made of CMC and a ring support structure, each segment of the ring comprising a base from which extend, radially outward, an upstream attaching lug and a downstream attaching lug axially spaced apart from one another, the support structure including an upstream radial flange and a downstream radial flange between which are retained the attaching lugs of each segment, and the assembly including, for each segment, at least a first pin traversing the downstream attaching lug and the downstream radial flange and at least a second pin traversing the upstream attaching lug and the upstream radial flange. The ring assembly further includes an annular spacer plate mounted between the downstream attaching lug of the ring segment and the downstream radial flange of the ring support structure.

### TECHNICAL FIELD

The invention relates to a turbine ring assembly for a turbomachine in which the assembly comprises a plurality of angular ring segments made of ceramic matrix composite material placed end-to-end to form a turbine ring.

The field of application of the invention is in particular that of aeronautical gas turbine engines. The invention is however applicable to other turbomachines, for example industrial turbines.

### PRIOR ART

In the case of fully metallic turbine ring assemblies, it is necessary to cool all the elements of the assembly and in particular the turbine ring which is subject to the hottest flows. This cooling has a significant impact on the engine performance since the cooling flow used is drawn off the primary flow of the engine. Moreover, the use of metallic material for the turbine ring limits the possibilities for increasing the temperature at the turbine due to the mechanical limits specific to this type of material, which could however make it possible to improve the performance of aeronautical engines.

To attempt to solve these problems, it has been envisioned to make turbine ring segments out of ceramic matrix composite (CMC) material to dispense with the employment of a metallic material.

CMC materials have good mechanical properties making them suitable for constituting structural parts and advantageously retain these properties at high temperatures. The employment of CMC materials has advantageously made it possible to reduce the cooling flow required during operation and therefore to increase the performance of turbomachines. Moreover, the implementation of CMC materials advantageously makes it possible to reduce the mass of turbomachines and to reduce the hot expansion effect encountered with metallic parts.

The documents FR 2 540 939, and FR 2 955 898, which disclose turbine ring assemblies, are moreover known.

The ring segments include an annular base, the inner face of which defines the inner face of the turbine ring and an outer face from which two lugs radially extend, the ends of which are retained between the two flanges of a metallic ring support structure.

The integration of a CMC ring comprises a radial retainment of the part, partially provided by one or more axial pins. In the known document FR 3 086 327, there are four pins, two upstream and two downstream.

The use of CMC ring segments thus makes it possible to significantly reduce the ventilation needed to cool the turbine ring, and therefore to increase the efficiency. They also allow a mass saving since they are lighter than the metallic alloys conventionally used.

However, since the CMC has different mechanical behavior from a metallic material, its integration and also the way of positioning it within the turbine have had to be rethought. Specifically, the CMC may be damaged by press-fitted assemblies (usually used for metallic rings) and its thermal expansion is lower than a metallic material.

There is a need to improve existing turbine ring assemblies and their installation, and particularly turbine ring assemblies employing a CMC material in order to reduce the intensity of the mechanical stresses to which the ring segments are exposed during the operation of the turbine.

Axially, the ring is clamped between two metallic lugs. The downstream lug is directly connected to the casing, describing a ring made as one part, providing increased sealing by comparison with a solution with segmented spacer. The upstream lug comprises a segmented flange screwed onto the casing.

These two metallic lugs comprise a lip in order to better control the ring-casing sealing. For each ring segment, this lip is straight so that there is always a linear contact, and thus good sealing, even if the ring tips.

Another flange is dedicated to the take-up of the force of the high-pressure nozzle guide vane (HP NGV force). It makes it possible to take up the HP NGV force and to transfer it directly to the casing, without making the forces travel through the CMC ring.

To ensure the hot axial contact between the ring and the straight lips of the upstream and downstream lugs, a preliminary clamping is done during installation. This preliminary clamping makes it possible to absorb the axial differential expansion between the CMC ring and the metallic parts in contact. Thus, hot, the axial contact is preserved and the sealing between the air path cavity and the cavity away from the air path is ensured.

In addition to ensuring the retainment of the part, the straight lips, or straight bearings, ensure the sealing between the cavity above the ring and the air path. It is this sealing that ensures the presence of a higher pressure in the ring cavity and makes it possible to combat potential reintroductions of air path gas at the outlet of the combustion chamber (too hot for metallic parts) in the cavities away from the air path. The maintaining of this seal at a sufficient level over the whole life of the technology is therefore of prime importance.

Tests were carried out to ensure the correct ageing of these contacts and the maintaining of the seal over the operating cycles.

The first results showed an increase in the leak over time, which is not acceptable as regards the successful maintaining at overpressure of the cavities away from the air path, in relation to the main air path.

After analysis, the formation of a metallic deposit on the CMC ring was observed. It appears that this wear is due to the differential thermal expansion at the ends of the bearing, the CMC ring expanding less than the non-segmented metallic parts at the interface, for a same temperature.

### SUMMARY OF THE INVENTION

This invention therefore has the main aim of making provision for a turbine ring assembly which does not have the aforementioned drawbacks while having a reduced mass and reducing, by the same amount, the intensity of the mechanical stresses to which the CMC ring segments are subjected during the operation of the turbine.

More specifically, the solution of this invention has the aim of limiting wear at the contacts between the CMC ring and the metallic parts.

This aim is achieved owing to a turbine ring assembly comprising a plurality of ring segments made of ceramic matrix composite material forming a turbine ring, defining an axial direction, a radial direction and a circumferential direction, and a ring support structure retained by a turbine casing, each ring segment comprising a base from which extend, radially outward, an upstream attaching lug and a downstream attaching lug axially spaced apart from one another, the ring support structure including an upstream radial flange and a downstream radial flange between which are retained the upstream attaching lug and the downstream attaching lug of each ring segment, and, to radially retain the ring segment in position with the ring support structure, the ring assembly comprising, for each ring segment, at least a first pin traversing the downstream attaching lug and the downstream radial flange and at least a second pin traversing the upstream attaching lug and the upstream radial flange.

The turbine ring assembly according to the invention is particularly noteworthy in that it further comprises an annular metallic sealing plate installed between the downstream attaching lug of the ring segment and the downstream radial flange of the ring support structure

The straight lips used in the prior art are replaced by a spacer plate disposed between the downstream attaching lug and the downstream radial flange. This sealing plate makes it possible to limit friction between the downstream radial flange and the downstream attaching lug and thus to limit wear at the contacts. This plate makes it possible to improve the tribology of the contact by smoothing the forces all along the part.

This consequently makes it possible to improve the operating performance of the turbine ring and to increase its life.

More explicitly, the sealing plate makes it possible to distribute the force over the entire tangential length of the ring segment, even as the casing transmits more forces in certain areas, due to a stiffness varying tangentially according to the integration.

According to a first aspect of the ring turbine assembly, the sealing plate can form a radial shroud extending over at least a part of the radial length of the downstream attaching lug, the sealing plate being traversed by said at least one first pin to be radially retained with the ring segment and the ring support structure.

Said at least one hole for which provision is made in the sealing plate to be traversed by said at least one pin used for the radial and tangential retainment of the turbine ring with the ring support structure makes it possible to easily integrate the plate without requiring an adjustment of the reference geometry such as the addition of additional parts generating a very significant axial bulk.

The retainment of the sealing plate is necessary to avoid ingestion in the primary air path in the event of increases in clearance during operation (unforeseen event generating non-nominal thermal gradients in parts for example).

According to a second aspect of the turbine ring assembly, the sealing plate may comprise a thickness between 0.1 mm and 1 mm, the thickness being measured along the axial direction.

The thinness of the sealing plate makes it possible to have a contact generating less wear. Specifically, this will, by virtue of its flexibility, allow its distortion in areas where the contact forces are highest, thus relieving the parts made of CMC material in the same locations.

According to a third aspect of the turbine ring assembly, the thickness of the sealing plate may vary along the circumferential direction of the shroud formed by the sealing plate.

The variation of the thickness of the plate along the circumferential direction makes it possible to evenly distribute the forces over the ring segment made of CMC material, with for example twice the thickness near the inter-segment areas (significant forces) as at the middle of the ring.

According to a fourth aspect of the turbine ring assembly, the sealing plate may comprise a radial length between 3 mm and 10 mm.

According to a fifth aspect of the turbine ring assembly making provision for an alternative embodiment of the sealing plate, the sealing plate may form an axial ring extending along the axial direction, with a thickness measured along the radial direction and a length along the axial direction greater than the thickness, the downstream radial flange including a first groove extending along the circumferential direction, and the downstream attaching lug including a second groove extending along the circumferential direction facing the first groove, the first groove and the second groove each having a depth measured along the axial direction less than half the axial length of the sealing plate.

This embodiment makes it possible to reduce the value of the press fitting between the flanges of the ring support and the attaching lugs of the ring. One thus obtains an order of magnitude of a few hundredths of millimeters to 0.2 mm for an initial value of 0.2 to 0.3 mm. Contact stresses are reduced as well as the consequent risks of damage.

According to a sixth aspect of the turbine ring assembly, the sealing plate can be made of a metallic material chosen from among A600®, Hastelloy X®, HA188®, and HS25®.

A600® has an intermediate expansion coefficient between that of metallic parts made of Wasploy® and CMC. Hastelloy X® and HA188® can be used to manufacture a thin part, in the order of 0.1 mm in particular, with a good withstand at high temperatures. HS25 has good behavior in contact with CMC (very little chemical interaction).

In addition, in the event of a thermal gradient between the parts, the casing rubs against this metallic sealing plate, this contact not generating any notable wear. The differential gradient between the turbine ring made of CMC material and this sealing plate is itself lower than if there was a direct contact between the part made of CMC material and the casing. This is all the more true if one uses a material with intermediate thermal expansion between the metallic casing and the CMC ring for the sealing plate.

According to a seventh aspect of the turbine ring assembly, the sealing plate may comprise a plurality of plate segments together forming a ring coaxial with the turbine ring, the sealing plate segments comprising a length between 50 mm and 150 mm in the circumferential direction of the turbine ring.

According to an eighth aspect of the turbine ring assembly, the first pin and the second pin are two transverse pins, each transverse pin traversing the upstream attaching lug and the downstream attaching lug of the ring segment and the ring support, to retain the ring segment and the ring support secured to one another.

According to the invention, the turbine ring assembly further comprises another annular metallic sealing plate mounted between the upstream attaching lug of the ring segment and the upstream radial flange of the ring support structure.

The invention also has the subject of a turbomachine comprising an assembly as defined previously.

### BRIEF DESCRIPTION OF THE DRAWINGS

FIG. 1 is a schematic section view in a plane comprising the axial direction and the radial direction of a turbine ring assembly according to a first embodiment of the invention.

FIG. 2 shows a perspective view of a portion of the turbine ring assembly of FIG. 1.

FIG. 3 shows a partial perspective view of a portion of the turbine ring assembly of FIG. 1.

FIG. 4 shows a perspective view of a portion of a turbine ring assembly according to a second embodiment of the invention.

FIG. 5 shows a schematic section view along a plane comprising the axial direction and the radial direction of the turbine ring assembly of FIG. 4.

### DESCRIPTION OF THE EMBODIMENTS

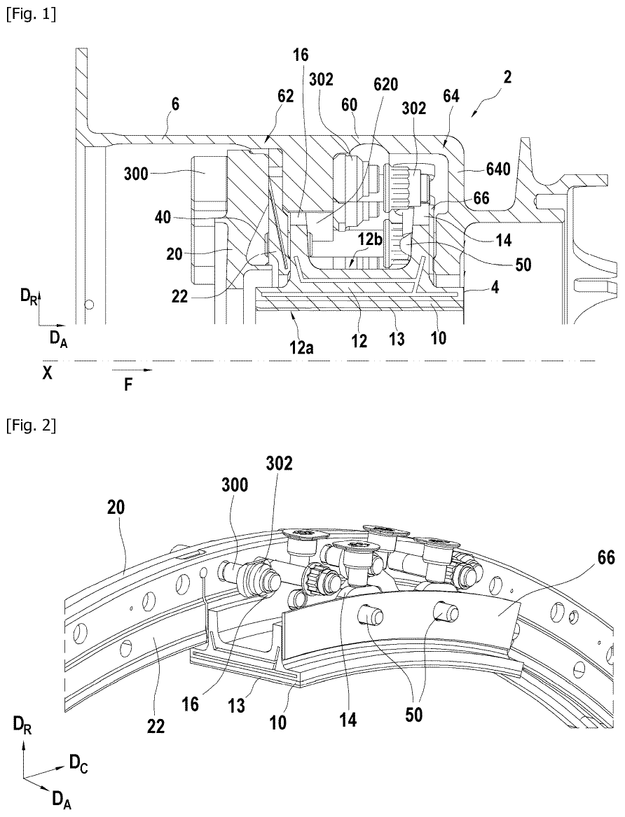

FIG. 1 schematically represents a turbine ring assembly 2 according to a first embodiment of the invention. FIG. 1 is a section view along a plane comprising the radial direction DR and the axial direction DA.

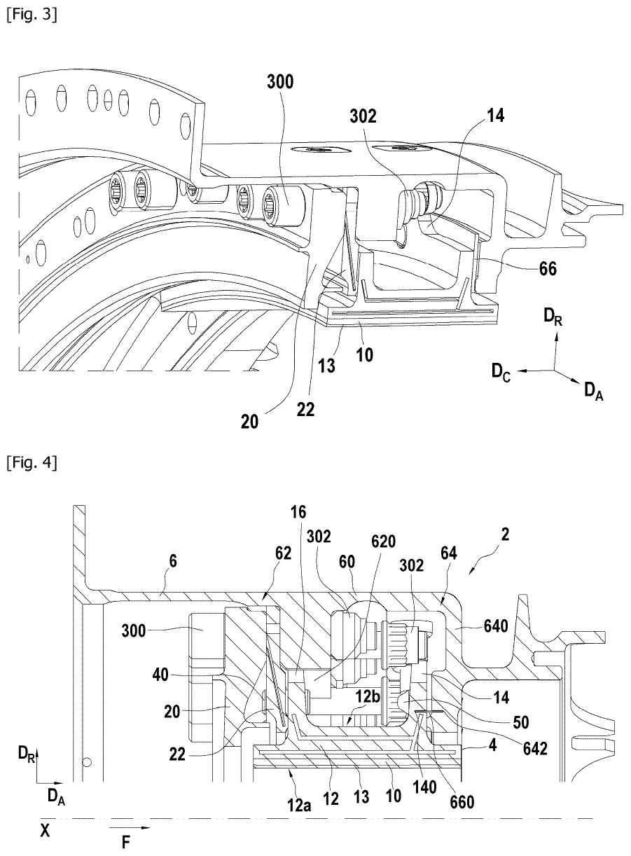

FIGS. 2 and 3 show two perspective views of a portion of the turbine ring assembly of FIG. 1.

The turbine ring assembly 2 shown on FIGS. 1 to 3 particularly comprises a turbine ring 4 made of ceramic matrix composite (CMC) material centered on a longitudinal axis X-X, a metallic ring support structure 6 affixed to a turbine casing not shown for more clarity. The turbine ring 4 surrounds a set of turbine blades, not shown.

In the remainder of the text, throughout the text, the terms “upstream” and “downstream” are used with reference to the direction of flow of the gas stream F through the blades indicated by an arrow.

Moreover, the turbine ring 4 is formed of a plurality of angular ring segments 10 which are placed end-to-end along the circumferential direction to form a ring. On FIG. 1, the arrow DA indicates the axial direction of the turbine ring while the arrow DR indicates the radial direction of the turbine ring.

Each angular ring segment 10 has a section substantially in the shape of an inverted Pi (or π) with a base 12 provided with an inner face 12a which defines an angular portion of the inner face of the turbine ring 4 and which is typically provided with a layer of abradable, or abrasive, coating 13 also serving as a thermal and environmental barrier.

Two attaching lugs spaced axially apart, a downstream attaching lug 14 and an upstream attaching lug 16, extend radially from the outer face 12b of the base 12 opposite the inner face 12a. These attaching lugs 14 and 16 extend over the entire width of each ring segment 10 (in the circumferential direction).

The ring support structure 6 comprises a shroud 60 extending around the axis X-X, along with an upstream radial flange 62 and a downstream radial flange 64 extending radially inward from the shroud 60. The downstream radial flange 64 comprises a fastening portion 640 radially protruding from the shroud 60, and the upstream radial flange 62 comprises a fastening portion 620 radially protruding from the shroud 60, as well as a first upstream flange 20 and a second upstream flange 22 affixed to the fastening portion 620 radially protruding from the upstream radial flange 62 using bolts 300 and nuts 302. The first upstream flange 20 is disposed upstream of the second upstream flange 22. The bolts 300 axially traverse the first upstream flange 20, the second upstream flange 22 and the fastening portion 620 of the upstream radial flange 62.

The upstream radial flange 62 and the downstream radial flange 64 thus form two hooking flanges of the ring 4 axially disposed between the downstream attaching lug 14 and the upstream attaching lug 16 of the ring segments 10.

The turbine ring assembly 2 further comprises upstream pins 40 and downstream pins 50. The upstream pins 40 traverse the second upstream flange 22 of the upstream radial flange 62 as well as the upstream lug 16 of a ring segment 10. The downstream pins 50 at least partially traverse the downstream radial flange 64, and more specifically the radially-protruding fastening portion 640, as well as the downstream attaching lug 14.

The turbine ring assembly according to the invention further comprises an annular metallic sealing plate 66 mounted between the downstream attaching lug 14 of the ring segment 10 and a fastening portion 640 of the downstream radial flange 64 of the ring support structure 6.

The sealing plate 66 makes it possible to distribute the force over the entire tangential length of the ring segment 10, even as the casing transmits more forces in certain areas, due to a stiffness varying tangentially according to the integration.

The sealing plate 66 forms a radial shroud, i.e. forming a shroud having a length along the radial direction DR that is greater than its measured thickness along the axial direction DA. The radial shroud formed by the sealing plate 66 extends, along the radial direction, over at least a part of the radial length of the downstream attaching lug 14.

The sealing plate 66 comprises a plurality of plate segments together forming the radial shroud, this radial shroud being coaxial with the turbine ring 4. The sealing plate segments comprise a length between 50 mm and 150 mm in the circumferential direction DC of the turbine ring 4.

In a variant, the sealing plate 66 can be formed of a ring made of a single, same part.

The sealing plate 66 further comprises axial holes each traversed by a downstream pin 50 to ensure the radial retainment of the sealing plate 66 with the ring segment 10 and the ring support structure 6.

The sealing plate 66 comprises a thickness, along the axial direction DA, between 0.1 mm and 1 mm. This thinness makes it possible to have a contact generating less wear.

In certain embodiments, the axial thickness of the sealing plate 66 can vary along a circumferential direction of the shroud formed by the sealing plate, the circumferential direction being orthogonal to the radial direction DR and to the axial direction DA and describing a circle about the axis X.

The sealing plate comprises a length along the radial direction DR between 3 mm and 10 mm.

The sealing plate is made of a metallic material chosen from among A600®, Hastelloy X®, HA188@, and HS25®.

A600® has an intermediate expansion coefficient between that of metallic parts made of Wasploy® and CMC. Hastelloy X® and HA188® can be used to manufacture a thin part, in the order of 0.1 mm in particular, with good withstand at high temperatures. HS25 has good behavior in contact with CMC (very little chemical interaction).

FIG. 4 schematically represents a perspective view of a portion of a turbine ring assembly according to a second embodiment of the invention.

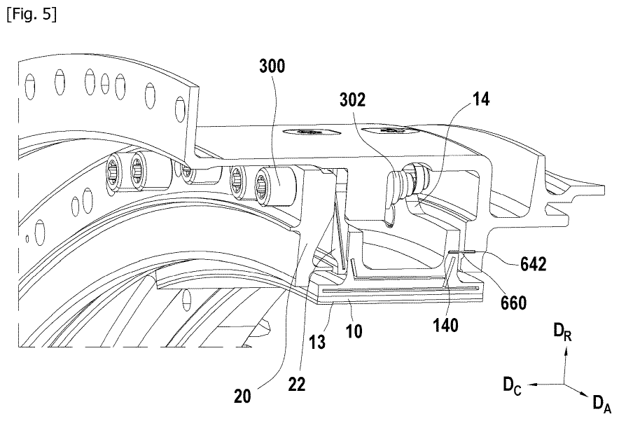

FIG. 5 schematically illustrates a section view along a plane comprising the radial direction DR and the axial direction DA of the ring assembly 2 of FIG. 4.

In this second embodiment illustrated on FIGS. 4 and 5, the sealing plate 660 forms an axial ring extending along the axial direction DA, with a thickness measured along the radial direction DR and a length measured along the axial direction DA, the axial length being greater than the radial thickness.

In the second embodiment, the downstream radial flange 64 includes a first groove 642 dug out of the attaching portion 640 and extending along the circumferential direction DC, and the downstream attaching lug 14 includes a second groove 140 extending along the circumferential direction DC facing the first groove 642, the first groove and the second groove each having a depth measured along the axial direction DA less than half the axial length of the sealing plate 660.

This invention thus makes provision for a turbine ring assembly having a reduced mass and reducing by the same amount the intensity of the mechanical stresses to which the CMC ring segments are subjected during the operation of the turbine.

1. A turbine ring assembly comprising a plurality of ring segments made of ceramic matrix composite material forming a turbine ring, defining an axial direction, a radial direction and a circumferential direction, and a ring support structure retained by a turbine casing, each ring segment comprising a base from which extend, radially outward, an upstream attaching lug and a downstream attaching lug axially spaced apart from one another, the ring support structure including an upstream radial flange and a downstream radial flange between which are retained the upstream attaching lug and the downstream attaching lug of each ring segment,
and, to radially retain the ring segment in position with the ring support structure, the ring assembly comprising, for each ring segment, at least a first pin traversing the downstream attaching lug and the downstream radial flange and at least a second pin traversing the upstream attaching lug and the upstream radial flange, wherein it further comprises an annular metallic sealing plate mounted between the downstream attaching lug of the ring segment and the downstream radial flange of the ring support structure, and another annular metallic sealing plate mounted between the upstream attaching lug of the ring segment and the upstream radial flange of the ring support structure.

2. The turbine ring assembly as claimed in claim 1, wherein the sealing plate forms a radial shroud extending over at least a part of the radial length of the downstream attaching lug, the sealing plate being traversed by said at least one first pin to be radially retained with the ring segment and the ring support structure.

3. The turbine ring assembly as claimed in claim 2, wherein the sealing plate comprises a thickness between 0.1 mm and 1 mm, the thickness being measured along the axial direction.

4. The turbine ring assembly as claimed in claim 3, wherein the thickness of the sealing plate varies along the circumferential direction of the shroud formed by the sealing plate.

5. The turbine ring assembly as claimed in claim 2, wherein the sealing plate comprises a radial length between 3 mm and 10 mm.

6. The turbine ring assembly as claimed in claim 1, wherein the sealing plate forms an axial ring extending along the axial direction, with a thickness measured along the radial direction and a length along the axial direction greater than the thickness, the downstream radial flange including a first groove extending along the circumferential direction, and the downstream attaching lug including a second groove extending along the circumferential direction facing the first groove, the first groove and the second groove each having a depth measured along the axial direction less than half the axial length of the sealing plate.

7. The turbine ring assembly claimed in claim 1, wherein the sealing plate is made of a metallic material chosen from among A600®, Hastelloy X®, HA188®, and HS25®.

8. The turbine ring assembly as claimed in claim 1, wherein the sealing plate comprises a plurality of sealing plate segments together forming a ring coaxial with the turbine ring, the plate segments comprising a length between 50 mm and 150 mm in the circumferential direction (DC) of the turbine ring.

9. The turbine ring assembly as claimed in claim 1, wherein the first pin and the second pin are two transverse pins, each transverse pin traversing the upstream attaching lug and the downstream attaching lug of the ring segment and the ring support to retain the ring segment and the ring support secured to one another.

10. turbomachine comprising an assembly as claimed in claim 1.
